(19) United States
(12) Patent Application Publication
(10) Pub. No.: US 2007/0101270 A1
(43) Pub. Date: May 3, 2007

(54) Method and system for generating a presentation file for an embedded system

(75) Inventor: Yi-Ta Chianglin, Hsinchu (TW)

Correspondence Address: BACON & THOMAS, PLLC, 625 SLATERS LANE, FOURTH FLOOR, ALEXANDRIA, VA, 22314, US

(73) Assignee: Premier Image Technology Corporation, Taipei (TW)

(21) Appl. No.: 11/345,323

(22) Filed: Feb. 2, 2006

(30) Foreign Application Priority Data
Oct. 27, 2005 (TW) 094137693

(51) Int. Cl. G06F 9/00

(52) U.S. Cl. 715/730; 715/764; 715/864

(57) ABSTRACT

A presentation file for an embedded system can be generated when a PC-based presentation file is displayed on a personal computer. The presentation file for an embedded system includes a plurality of digital images and a plurality of tags, so that the embedded system, such as a digital camera, can use its operating interface (e.g. right/left buttons) to provide a presentation by utilizing each tag.

### BACKGROUND OF THE INVENTION

1. Field of the Invention

The present invention relates to a method for generating a presentation file for an embedded system, such as mobile phones, smart phones, PDAs, and digital cameras.

2. Description of the Related Art

For most users, almost all presentation files are generated by software, such as the Power-Point program, because this kind of software provides many various animations, audio clips and illustrations. Although presentation files are typically projected onto large screens, sometimes the presentation file needs to be displayed on a small screen, such as found in a notebook computer. However, to do so the user must use a safe computer, as otherwise the presentation file may be copied or pirated.

Many portable electronic devices have small screens, such as mobile phones and digital cameras, and it would offer more convenience for users if the screens on these devices could be used for the displaying of presentation files.

Therefore, it is desirable to provide a method for generating a presentation file for an embedded system to mitigate and/or obviate the aforementioned problems.

### SUMMARY OF THE INVENTION

A main objective of the present invention is to provide a method for generating a presentation file for an embedded system, such as mobile phones, smart phones, PDAs, and digital cameras.

Another objective of the present invention is to provide an embedded system with presentation function.

In order to achieve the above-mentioned objective, the method of the present invention comprises:
providing an image recording means to record a presentation image displayed by the PC-based presentation file when the personal computer plays the PC-based presentation file;
performing tag recording when the personal computer plays the PC-based presentation file if a changing image key on the personal computer is pressed; and
storing a presentation file for the embedded system on a storage device of the personal computer when displaying of the PC-based presentation file is completed on the personal computer;
wherein the presentation file for an embedded system includes a plurality of digital images and a plurality of tags so that the embedded system can use an operating interface to provide a presentation by utilizing each tag.

Other objects, advantages, and novel features of the invention will become more apparent from the following detailed description when taken in conjunction with the accompanying drawings.

### BRIEF DESCRIPTION OF THE DRAWINGS

FIG. 1 is an implementation diagram of the present invention.

FIG. 2 is a flowchart of a method for generating a presentation file for an embedded system according to the present invention.

FIG. 3 is a schematic drawing of an embedded system displaying a presentation file according to the present invention.

FIG. 4 shows an embodiment of a file format of the presentation file displayed by an embedded system.

FIG. 5 is a schematic drawing of a digital camera.

FIG. 6 is a circuit block drawing of a digital camera.

FIG. 7 is a flowchart of the embedded system showing the presentation file according to the present invention.

FIG. 8 is a schematic drawing of a mobile phone.

FIG. 9 is a schematic drawing of a PDA.

### DETAILED DESCRIPTION OF THE PREFERRED EMBODIMENT

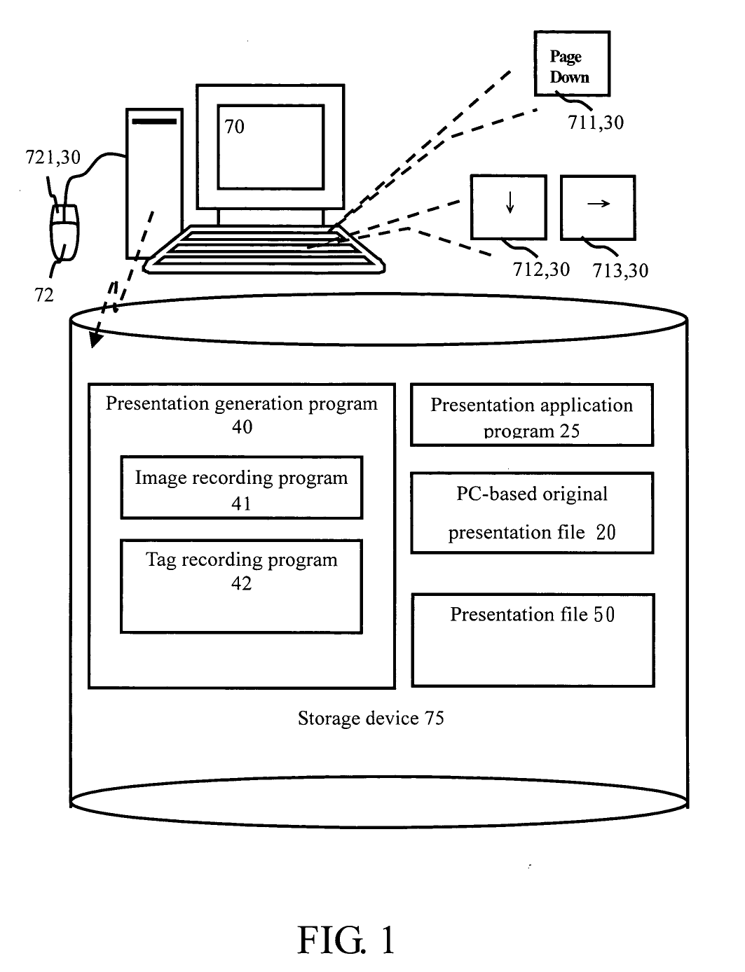

Please refer to FIG. 1. FIG. 1 is an implementation diagram of the present invention. A personal computer 70 comprises a storage device 75 (such as a hard drive, a CD drive, a memory stick, or a combination of these devices). A user can utilize a presentation application program 25 (such as PowerPoint presentation software) to produce a PC-based original presentation file 20 (such as a PowerPoint presentation file). In the present invention, the user can generate a presentation file 50 for an embedded system when the PC-based original presentation file 20 is displayed on the personal computer 70.

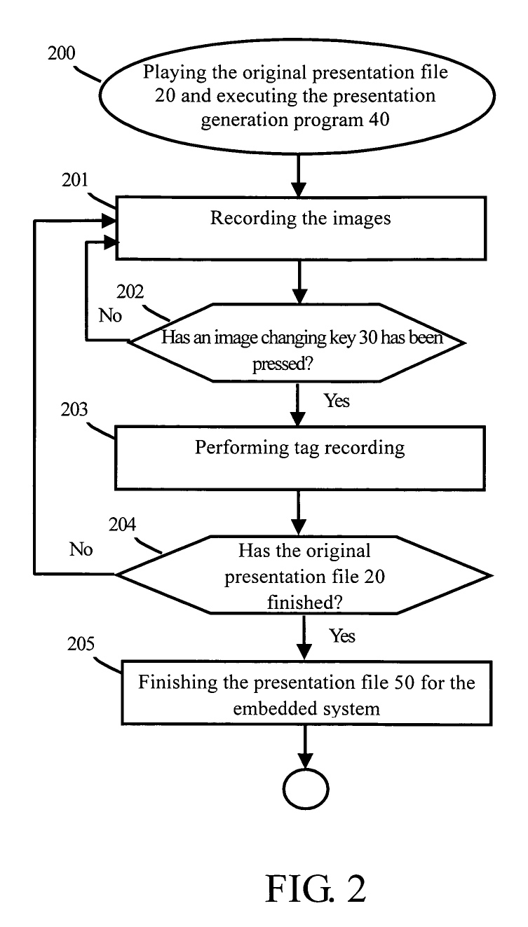

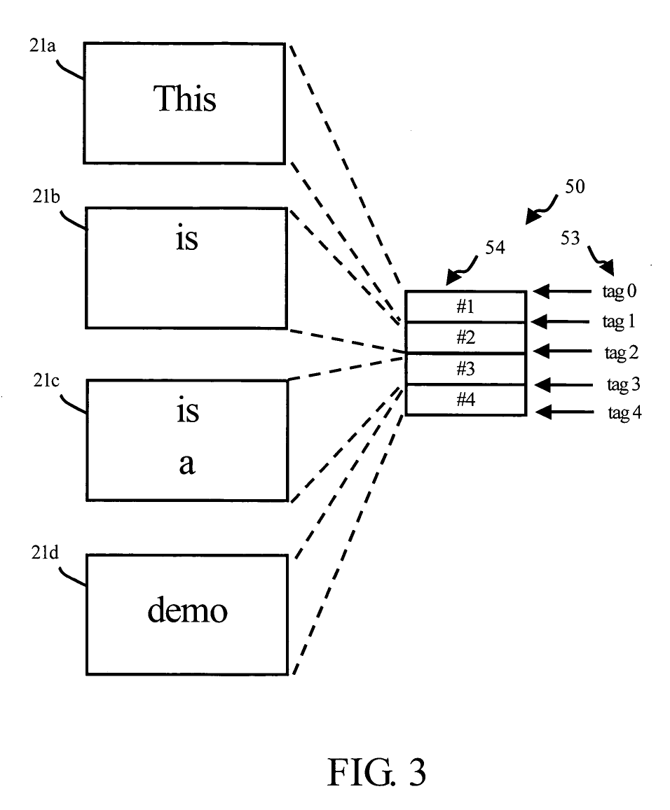

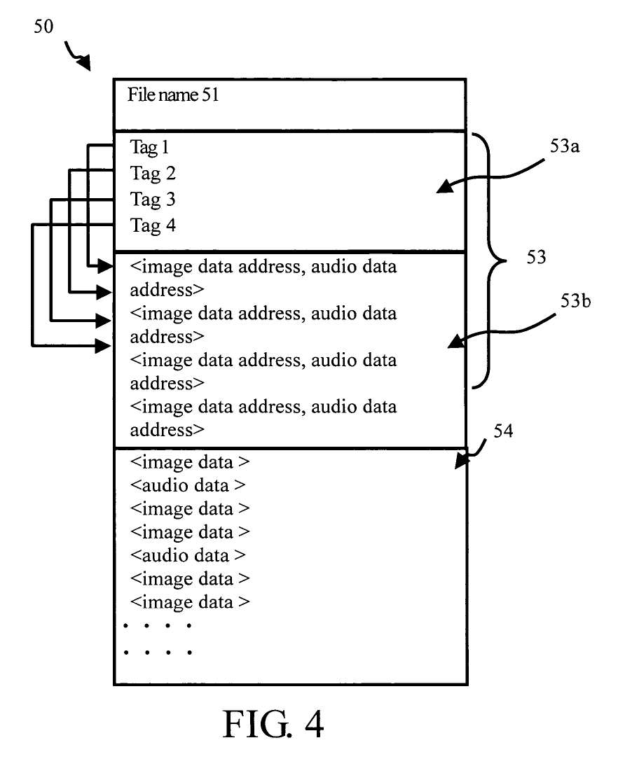

In the present invention, a presentation generation program 40 is stored in the storage device 75 so the processor of the personal computer 70 can execute the presentation generation program 40 to generate the presentation file 50 for the embedded system. The presentation generation program 40 comprises an image recording program 41 and a tag recording program 42. Please refer to following FIG. 2, FIG. 3 and FIG. 4.

In the following, the presentation application program 25 is presented as a PowerPoint application program.

Step 200:

Playing the original presentation file 20 and executing the presentation generation program 40.

The presentation application program 25 has an editing mode and a display mode; in the display mode, images obtained from the original presentation file 20 are displayed on the personal computer 70 as full images.

The presentation generation program 40 may be executed in the background, so that no operating interfaces or information is shown in the image displayed that is based on the original presentation file 20, and hence the user will not see the presentation generation program 40 when the presentation application program 25 runs.

Since the typical operating system on the personal computer 70 can execute a plurality of programs at the same time, and as one program can call or start another program, no further description of the presentation generation program 40 is required.

Step 201:

Recording the images.

When the original presentation file 20 is loaded for display, the image recording program 41 starts to record the presentation images shown by the original presentation file 20.

Please refer to FIG. 3. The original presentation file 20 may have, for example, three presentation pictures:

a first presentation picture, as shown in presentation image 21a, showing: “This”;

a second presentation picture, as shown in presentation image 21c, showing: “is a”; the second presentation picture first shows “is” (as a presentation image 21b, and when the user presses the ┌↓┘ key 712, the second presentation picture first shows “is a”; and

a third presentation picture, as shown in presentation image 21d, showing: demo.

When step 201 is executed for the fist time, the presentation image 21a is recorded.

Step 202:

Has an image changing key 30 has been pressed?

Taking the PowerPoint application program as an example, a ┌page downs┘ key, a ┌↓┘ key 7l2, a ┌→┘ key 7l3 on a keyboard 71 and a left button 721 on a mouse 72 can all be pressed to show a subsequent image (which is not necessarily the next page). The subsequent image could be the next page, or different text or drawings in the same page, or an animation. In this invention, the image changing key 30 is used for changing to a subsequent image; in the PowerPoint application program, the image changing key 30 can be the ┌page down┘ key 711, the ┌↓┘ key 712, the ┌→┘ key 713 on the keyboard 71 and the left button 721 on the mouse 72.

When the image changing key 30 is pressed, the presentation generation program 40 performs step 203. For the presentation application program 25, if the image changing key 30 is pressed, it shows the subsequent image.

Step 202 is a monitoring step; when the image changing key 30 is not pressed, step 201 is repeatedly performed.

Step 203:

Performing tag recording.

By way of example, the presentation image 21a is first shown; after the image changing key 30 is pressed, the tag recording program 42 is executed to record a tag1, which marks an ending point of the presentation image 21a and also marks a beginning point of the presentation image 21b.

In this embodiment, the presentation image sequentially generates tag1, tag2 and tag3 when the image changing key 30 is pressed, and the presented images are presentation image 21a, presentation image 21b, presentation image 21c and presentation image 21d.

Please refer to FIG. 3. A tag0 can be used for representing a beginning point of the first presentation image (such as the presentation image 21a), but tag0 is not required, since the beginning point of the first presentation image is known. But for management convenience, when step 201 is executed for the first time, tag0 can be generated automatically (without the image changing key 30 being pressed).

Step 204:

Has the original presentation file 20 finished?

When the original presentation file 20 has finished, step 205 is performed; otherwise step 201 is continuously performed. However, step 204 is for continuous monitoring.

Please refer to FIG. 3 again; tag4 is not required, because the ending point of the last presentation image is known. But for management convenience, the last tag (which is tag4 in this embodiment) can be generated.

Step 205:

Finishing the presentation file 50 for the embedded system.

Step 201 and step 203 are used for continuously generating the presentation file 50 for the embedded system; when the original presentation file 20 has finished, the presentation file 50 for the embedded system is completed and can be stored on the storage device 75 (such as a memory stick or a hard disk).

Please refer again to FIG. 3. The presentation file 50 for the embedded system comprises a presentation data area 54 for storing data for the presentation images 21a, 21b, 21c, 21d, and a tag area 53 for storing positions of tag0˜tag4 in the presentation data area 54.

The presentation file 50 for the embedded system can be in many different formats; it can even include a plurality of files, such as files for storing the presentation images 21a, 21b, 21c, 21d and files for storing tag0˜tag4. Please refer to FIG. 4, which shows an embodiment for a file format of the presentation file 50 of the embedded system. The format of the presentation file 50 for the embedded system may be divided into four areas, such as:

a file name area 51 for storing a plurality of file names;

a tag recording area 53a for recording each tag, such as tag1˜tag4;

a tag indicating area 53b for recording the positions of each tag in the presentation data area 54, such as an image data address and audio data for tag1 in the presentation data area 54; the above-mentioned step 201 can also record audio, not being limited to just images, and the corresponding tag records the address of the image data and the address of the audio data; the tag recording area 53a and the tag indicating area 53a, 53b are equivalent to the tag area 53 shown in FIG. 3; and

the presentation data area 54 for storing image data and audio data.

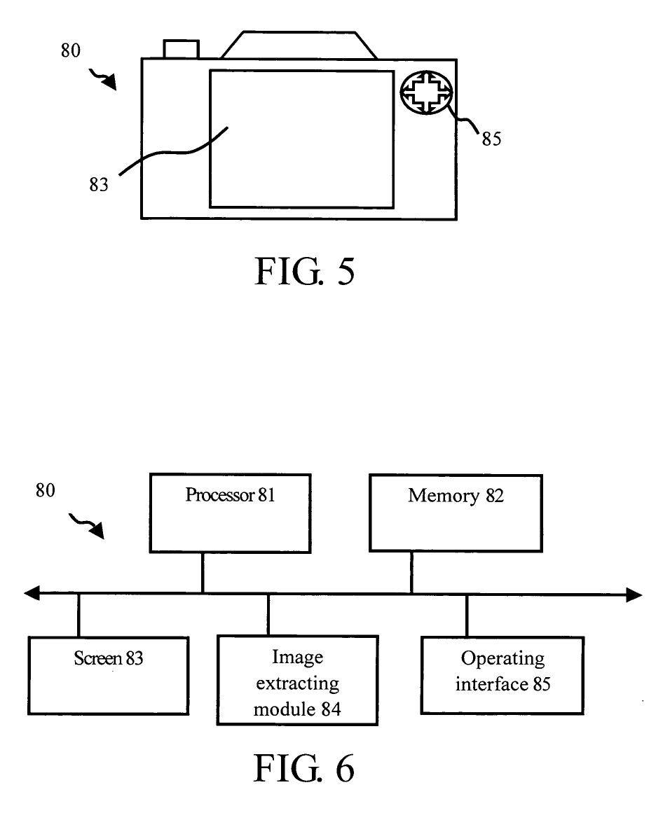

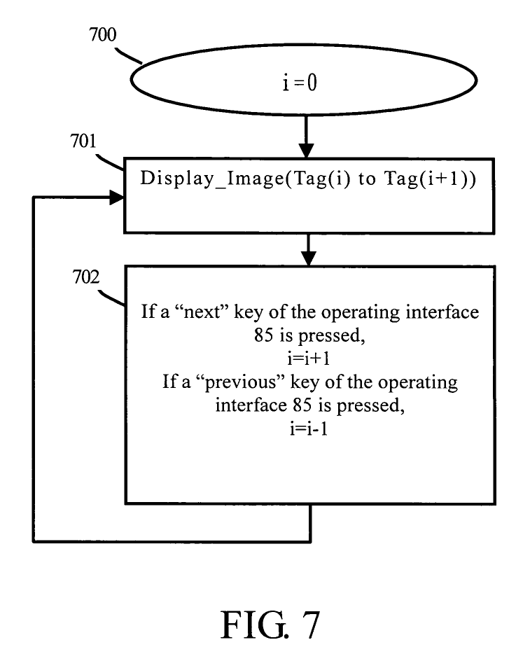

When the presentation file 50 for the embedded system has finished, it can be run by the embedded system. The embedded system can be a mobile phone, a smart phone, a PDA, or a digital camera. Taking a digital camera 80 as an example, and with reference to FIG. 5 and FIG. 6, the digital camera 80 comprises a processor 81, a memory 82, a screen 83, an image extracting module 84 and an operating interface 85. More advanced digital cameras even include microphones and speakers (not shown). Usually, the memory 82 includes an internal memory and an extended memory (such as an SD or a CF card), and the internal memory stores system software and application programs. The presentation file 50 for the embedded system can be stored in the extended memory so that the application program can read it.

Since the presentation file 50 for the embedded system includes the tag area 53, the user can use the left and right keys, or the up and down keys, in operating interface 85 to operate the display of the presentation file 50 for the embedded system. A flowchart of the application program for displaying the presentation file 50 for the embedded system is presented in the following:

Step 700:

i=0; the variable i is set to 0.

Step 701:

Display image (tag(i) to tag(i+1)); the images indicated by tag(i) to tag(i+1) are displayed.

Step 702:

If a “next” key (which is usually the right arrow key or the down arrow key) of the operating interface 85 is pressed, then i=i+1. But when i>maximum value for i, then i=maximum value for i, (for example, if tag(4) is the last tag, then the maximum value for i is 4) and the display procedure finishes.

If a “previous” key (which is usually the left arrow key or the up arrow key) of the operating interface 85 is pressed, then i=i−1. But when i<0, then i=0.

Step 701 is then executed again.

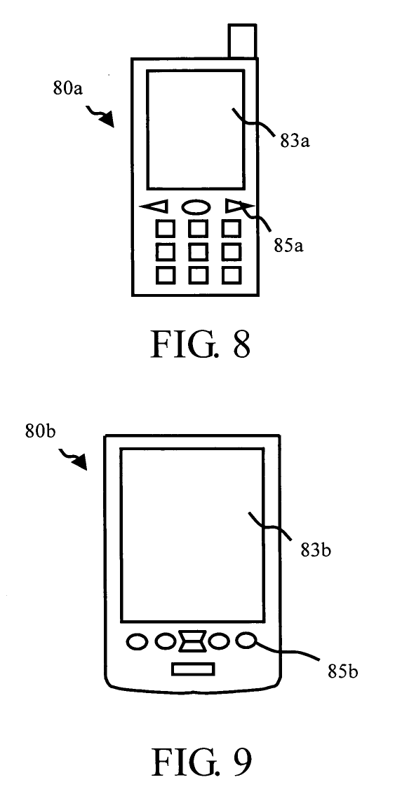

The embedded system can be used in the digital camera 80. The embedded system may also be used in a mobile phone 80a (as shown in FIG. 8), since the mobile phone 80a also has a processor, a memory, a screen 83a and an operating interface 85a.

Similarly, the embedded system can be used in a PDA 80b (as shown in FIG. 9), since the PDA 80b has a processor, a memory, a screen 83b and an operating interface 85b.

To reduce the size of the presentation file 50 for the embedded system, if the presentation image is a still picture, it may be represented by a single image. Additionally, all image data or audio data stored in the presentation file 50 for the embedded system may be compressed, using such codes as MJPEG, MP3, MP4 or similar compression formats.

Although the present invention has been explained in relation to its preferred embodiment, it is to be understood that many other possible modifications and variations can be made without departing from the spirit and scope of the invention as hereinafter claimed.

What is claimed is:

1. A method for generating a presentation file for an embedded system when a PC-based presentation file is displayed on a personal computer, the method comprising:
providing an image recording means to record a presentation image displayed by the PC-based presentation file when the personal computer plays the PC-based presentation file;
performing tag recording when the personal computer plays the PC-based presentation file if a changing image key on the personal computer is pressed; and
storing a presentation file for the embedded system on a storage device of the personal computer when displaying of the PC-based presentation file is completed on the personal computer;
wherein the presentation file for an embedded system includes a plurality of digital images and a plurality of tags so that the embedded system can use an operating interface to provide a presentation by utilizing each tag.

2. The method as claimed in claim 1, wherein the changing image key is a “down” button or a “left” key on a computer mouse.

3. The method as claimed in claim 1, wherein the tag is used for recording a corresponding position of the image digital data.

4. The method as claimed in claim 1 further providing an audio recording means for recording audio from the PC-based presentation file.

5. The method as claimed in claim 1, wherein the embedded system is a digital camera.

6. The method as claimed in claim 1, wherein the embedded system is a mobile phone.

7. The method as claimed in claim 1, wherein the embedded system is a PDA.

8. A computer readable object for generating a presentation file for an embedded system when a PC-based presentation file is displayed on a personal computer, the object comprising a medium for recording a program, the medium comprising:
a program code for providing an image recording means to record a presentation image caused to be displayed by the PC-based presentation file when the personal computer plays the PC-based presentation file;
a program code for performing tag recording when the personal computer plays the PC-based presentation file if a changing image key on the personal computer is pressed; and
a program code for storing a presentation file for the embedded system on a storage device of the personal computer when the display of the PC-based presentation file completes on the personal computer;
wherein the presentation file for an embedded system includes a plurality of digital images and a plurality of tags.

9. The computer readable object as claimed in claim 8, wherein the changing image key is a “down” button or a “left” key on a computer mouse.

10. The computer readable object as claimed in claim 8, wherein the tag is used for recording a corresponding position of the image digital data.

11. The computer readable object as claimed in claim 8, wherein the embedded system is a digital camera.

12. The computer readable object as claimed in claim 8, wherein the embedded system is a mobile phone.

13. The computer readable object as claimed in claim 8, wherein the embedded system is a PDA.

14. An embedded system comprising a processor, a memory, a screen, and an operating interface, characterized by: the memory storing an application program and a presentation file for an embedded system, the processor capable of executing the application program and reading the presentation file for an embedded system; wherein the presentation file for an embedded system includes a plurality of digital images and a plurality of tags so that a user can present the digital images by employing the operating interface.

15. The embedded system as claimed in claim 14, wherein the presentation file for an embedded system is generated by the method claimed in claim 1.

16. The embedded system as claimed in claim 14, wherein the tag is used for recording a corresponding position of the digital image data.

17. The embedded system as claimed in claim 14, wherein the embedded system is a digital camera.

18. The embedded system as claimed in claim 14, wherein the embedded system is a mobile phone.

19. The embedded system as claimed in claim 14, wherein the embedded system is a PDA.
